(19) United States
(12) Patent Application Publication
(10) Pub. No.: US 2022/0201044 A1
(43) Pub. Date: Jun. 23, 2022

(54) POLICING OF DATA

(71) Applicant: BRITISH TELECOMMUNICATIONS PUBLIC LIMITED COMPANY, London (GB)

(72) Inventors: Peter WILLIS, London (GB); Philip EARDLEY, London (GB)

(21) Appl. No.: 17/604,372

(22) PCT Filed: Apr. 14, 2020
(86) PCT No.: PCT/EP2020/060395

§ 371 Date: Oct. 15, 2021

(30) Foreign Application Priority Data
Apr. 15, 2019 (EP) 19169314.2

(51) Int. Cl. H04L 9/40

(52) U.S. Cl. CPC H04L 63/20

(57) ABSTRACT

Methods and apparatus are disclosed for policing data being sent from a plurality of sending devices (11, 12, 12a, 21, 22) to one or more receiving devices (12, 12b, 19, 29) via a network device (15, 25) in a communication network (10, 20), where at least one sending device (11, 12a, 22) is configured to perform a sender-side policing function in respect of data to be sent via the network and to apply a verification mark to verify that it has done so, and at least one sending device (12, 21) is not so configured. According to one aspect, the network device (15, 25) receives data from one of the plurality of sending devices (11, 12, 12a, 21, 22), inspects the data to determine whether a verification mark has been applied thereto, and if not, performs an in-network policing function. If so, the network device does not perform the in-network policing function, instead performing no policing function or an alternative policing function in respect of the data in question.

### TECHNICAL FIELD

The present invention relates to methods of and apparatus for the policing of data being sent across a communications network (such as the internet, a part thereof, a private network or a network operator's network), the communications network having a plurality of network nodes via which data (in the form of data items such as IP packets, for example) received or forwarded from a sending device outside the network may be forwarded towards a receiving device.

### BACKGROUND

Customers of Internet Service Providers (ISPs) and other users of a network operator's network may use a wide variety of applications and services. While some of the traffic that a network operator's network may carry may have originated from inside the network operator's network, from devices operated by or under the control of the network operator, other traffic may have originated at and/or been forwarded by sending devices outside the network operator's network, arriving at the network operator's network via one of a number of edge nodes.

Network operators generally monitor the data that their networks carry, possibly for reasons of security, to prevent congestion, to prevent abuse, or to be able to levy charges for carrying data or impose limits on individual users or on other network operators for data carried. Such monitoring and any resulting imposition of sanctions (e.g. charging, dropping data above agreed thresholds, against a policy, or otherwise) may be termed “policing”.

Policing by a network operator may be performed at one or more edge nodes of the network, allowing data to be admitted to the network or prevented from doing so at all, but there may be a large number of such edge nodes (each acting as an ingress and/or an egress node), so it may be inefficient, inconsistent or otherwise disadvantageous to implement policing at each of a number of different edge nodes.

As an alternative to this, policing may be performed at one node (or at a number of nodes) within the network operator's network. This may allow for greater efficiency or consistency in terms of policing, but may mean that data which would not have been admitted to the network at all if policing had been performed at an ingress edge node needs to be carried at least a part of the way across the network in question, which may be disadvantageous for reasons of capacity or security, for example.

Referring to FIG. 1, this shows the typical entities that may perform roles on an end-to-end path via a network operator's network. In this example, a network operator's (or ISP's) network 10 is shown, via which an end-to-end path 14 is shown from a sending device 11 to a receiving device 19, either or both of which may be personal computing devices in local area networks (LANs) or elsewhere, servers or other computing devices in data-centres and/or in other ISP networks, or other networked devices. It will be understood that the sending device 11 and the receiving device 19 may in fact be performing both “sending” and “receiving” functions, and that the end-to-end path 14 (and individual links thereof) may be carrying data in both directions, but to simplify the description, the following explanation will be provided in relation to a situation where sending device 11 is simply acting as a sender of data while receiving device 19 is simply acting as a receiver of data, meaning that the end-to-end path 14 (and the links of which it is comprised) are only carrying data in one direction.

While all of the linked/networked entities shown in the figure may be regarded as being part of “a network”, the present description will generally regard entities topologically within or on the boundary of the network 10 as being “in the network 10” (in the sense that they are topologically within it and/or are under the operational or administrative control of the ISP or network operator), and other entities as being “outside the network 10”.

The network 10 is bounded by a number of edge nodes (generally 13) via which data from entities outside the network passes on entering the network 10, and via which data to entities outside the network passes on leaving the network 10. These edge nodes may function as routers, and may also perform other functions such as policing, admission control, etc.

Within the boundary of the network 10 are a number of routers (generally 15), each configured to inspect header data of data items they receive and forward these received items on towards their intended destinations (via one or more other routers 15 and/or via an edge node 13). While the primary function of routers 15 is generally to forward data they receive, one or more of routers 15 may also perform other functions such as policing, admission control, etc.

The figure also shows some routers (generally 12) outside network 10, including in particular a sender-side router 12a (between the sending device 11 and edge node 13a of network 10) and a receiver-side router 12b (between edge node 13b of network 10 and the receiving device 19), these two “external” routers being on the end-to-end path 14. There may be a number of such “external” routers on the end-to-end path 14 and elsewhere, and/or there may be other networks between the sending/receiving devices 11, 19 and the network 10, but the purpose of including external “sender-side” and “receiver-side” routers 12a and 12b in the figure is to illustrate that—from the point of view of network 10, at least—sender-side router 12a may be regarded as a “sending device” (albeit one sending/forwarding data that it has itself received from the “original” sending device 11), and receiver-side router 12b may be regarded as an intended “receiving device” (albeit one intended to receive data that is to be forwarded on to the eventual or intended “final” receiving device 19).

Returning to the issue of policing and looking into this in more detail, policing may involve one or more of the following, for example:
Security functionality: e.g. firewall functionality (to check traffic is from an allowed host or flow etc., or is going to a permitted destination, or is of a permitted type such as a particular protocol or protocol message type, etc.); functionality to prevent or mitigate a denial of service (DOS) attack (for example where many end-points collaborate to overwhelm a victim with requests or traffic).
Bandwidth management functionality: e.g. functionality to ensure compliance with a contract, through bandwidth allocation or shaping or dropping or downgrading the class of service or adding a marking (such as higher loss priority) or re-routing or forwarding over a different interface or simply reporting to a management system for offline action; functionality for packet pacing (so packets exit at a regular interval); handling in-cast, for example where many servers send to the same end-point at the same time; functionality for stopping or slowing down traffic, for example during a network emergency; functionality ensuring that the transmission rate follows the TCP algorithm correctly, etc.

Policing functions such as these are generally placed in the network at or near the edge node acting as the ingress node or attachment point for the sender in question, although some functions (such as handling in-cast) may be better placed at or near the edge node acting as the egress node or attachment point for the receiver in question.

Various other concepts and technologies which will be referred to in the following description will be briefly introduced here.

Reference will be made to the field of “Trusted Computing”. In general terms this is usually taken to refer to trusted hardware, indicating that an area of the computing hardware of a computing device is secured, i.e. that it can't (easily) be accessed by the computing device's user. A computing device may have a Trusted Platform Module or a Trusted Execution Environment. Trusted Computing technology is used for applications such as “BitLocker” (a hard-disc encryption facility), security (to try to reduce the chances of a user introducing viruses, etc.), and digital rights management (DRM). The concept of “Trusted Computing” is also applicable where the software is trusted—for example the virtualisation environment may be well-controlled and/or isolated from the tenant's (end-user's) software, or an application may be secured sufficiently, as is done with various electronic payment applications.

A White Paper entitled “Improving Premium Content Protection with the Trusted Execution Environment” dated September 2015, available online at:

https://globalplatform.org/wp-content/uploads/2018/04/GlobalPlatform_Premium_Content_WhitePaper2015.pdf

discusses a technology that uses a Trusted Execution Environment (TEE) to enable Premium Content to run in an isolated environment.

Reference will be made to the field of electronic or digital “watermarking”. A version of this is described in a paper entitled “Network Flow Watermarking: A Survey” (IEEE Communications Surveys and Tutorials, 19(1):512-530; United States: IEEE, 2017) by Iacovazzi, A. and Elovici, Y, available online at https://ieeexplore.ieee.org/stamp/stamp.jsp?tp=&arnumber=7570208

Network flow watermarking is a type of active traffic analysis in which packet features of selected flows are manipulated in order to add a specific pattern easily identifiable when the watermarked flows cross an observation point.

A paper entitled “Enhancing Datacenter Network Security and Scalability with Trusted End Host Monitors” by Alan Shieh, Srikanth Kandula and Albert Greenberg (22nd ACM Symposium on Operating Systems Principles. Oct. 11-14, 2009) discusses the idea of providing a trusted enforcement mechanism at the end-hosts in order to facilitate shifting policy enforcement from the network to end hosts

A paper entitled “Carousel: Scalable Traffic Shaping at End Hosts” by Ahmed Saeed et al (SIGCOMM '17, online: https://www.cc.gatech.edu/˜amsmti3/files/carousel-sigcomm17.pdf) discusses the idea of traffic shaping at end-hosts, in particular in a data-centre with virtualised hosts.

UK patent application GB2327317 (“Ericsson”) relates to access control and resource reservation in a communications network. According to this, a first network user “A” wishing to send data to a terminal “B” sends a user resource reservation request “REQ-U” to an access router “AR”. If the required bandwidth specified in the request REQ-U is available to user A, the router AR sends a network resource reservation request “REQ-N” to terminal B. If the required bandwidth is available across the network, an acknowledgement is sent from terminal B to router AR and then the router AR sends a “ticket message” to user A containing all necessary connection information. The ticket message must then be included in the data transmission from user A to terminal B. The ticket message cannot be altered by user A and may be protected by a digital signature. The ticket message is used to police access to the network and may include information about allocated bandwidth, priority level allocated, quality of service guarantee to user A and time of expiry thereof, and source and destination addresses. Thus, information needed for admission control is not stored in the network on a per call basis, but can be extracted by the network from the ticket messages associated with every transmission which gains access in order to calculate the total amount of resources which have been allocated in every priority level on every link in the network. The network admission control function can thus determine whether a new resource reservation request can be accepted. The network may be a private or public connectionless packet network, particularly the Internet.

A paper entitled “User-Network Policer: A New Approach for ATM Congestion Control” (V. F. Hartanto et al, IEEE INFOCOM '93, Conference on Computer Communications, Proceedings, San Francisco, USA, 1993, pp. 376-383 vol. 1) refers to asynchronous transfer mode (ATM) congestion control schemes in which the policing function is carried out at the network edge, which opens the possibility of cells being discarded or marked without reference to the actual message, noting that this can lead to degradation of service quality in the voice service or multiplication of the cell loss probability in the data service. The authors propose an approach to the policing function, called “user-network policer”, to resolve these problems which consists of a service-dependent user policer and a service-independent network policer. Users are responsible for policing and marking their traffic appropriately before sending them into the network. The network is only responsible for verifying the correctness of user policing and for transporting cells transparently across the network.

US patent application US2017337376 (“Reader”) relates to heuristic behavioural policing techniques of executable objects which dynamically adapt based on context to reduce false positive and false negative outcomes. The level of heuristic behavioural suspicion required to subject an inbound executable object to a policing action is determined by an adaptive suspicion threshold which is dynamically adjusted based on outcomes of processing recent executable objects. The invention recognizes that malware often arrives in waves, such as during a concerted attack on a network or an endpoint, so that dispositions of recent executable objects provide useful context for suspicion threshold adjustment.

US patent application US2013088997 (“Briscoe et al”) relates to techniques for monitoring, at a traffic management module in a data network, path characterisation information indicative of a dynamic network characteristic at a remote node outside the network. The method involves a traffic management module receiving a data unit from a remote node outside the network, and in the event that the data unit is encapsulated in an outer header and that an inner header of the data unit includes path characterisation information, performing the following in respect of the data unit: monitoring the path characterisation information in the inner header; and forwarding the data unit according to a first treatment category. In the event that these conditions are not met, the data unit is subjected to an alternative treatment.

European patent application EP2434775 (“Broadcom”) relates to techniques for supporting differentiated performance for multiple categories of packets in a passive optical network (PON), and in particular to an optical network unit (ONU) comprising a user network interface configured to receive from a network packets to be transmitted upstream over a PON. Each of the packets are marked with or classified as belonging to a first or a second category type. An upstream first in, first out (FIFO) queue stores the packets in such a way as to maintain an order as to when each is received. A counter maintains a first count value of an amount of data stored in the upstream FIFO queue of the first category type and a second count value of an amount of data stored in the upstream FIFO queue of the second category type.

### SUMMARY OF THE INVENTION

The inventors have appreciated that there are various advantages and disadvantages to a network operator associated with performing policing at different (topological) locations (i.e. at edge nodes, at one or more nodes within the network near ingress nodes, near egress nodes or more centrally in the network) and that different types of and different (topological) locations for performing policing may be applicable in relation to different situations, and in respect of data traffic of different types sent or forwarded into the network operator's network by different sending (including forwarding) entities.

According to a first aspect of the invention, there is provided a method of policing data being sent from a plurality of sending devices to one or more receiving devices via a network device in a communication network, the network device being under a network operator's control, the plurality of sending devices including:
one or more sending devices of a first type each having a secure computing environment under the network operator's control configured to perform a sender-side policing function in respect of data to be sent via the network and to apply a verification mark to said data verifying to the network device that the sender-side policing function has been performed; and
one or more sending devices of a second type not configured to perform the sender-side policing function in respect of data to be sent via the network nor to apply a verification mark to said data verifying to the network device that the sender-side policing function has been performed;

the method comprising, at the network device:
receiving data from one of the plurality of sending devices;
inspecting the data in order to determine whether the data has had a verification mark applied thereto by a sending device having a secure computing environment under the network operator's control verifying to the network device that the sender-side policing function has been performed in respect of the data;
in the event of a determination that the data has not had a verification mark applied thereto by a sending device having a secure computing environment under the network operator's control verifying to the network device that the sender-side policing function has been performed in respect of the data, performing an in-network policing function at the network device;
and otherwise not performing the in-network policing function at the network device.

If the network device does not perform the in-network policing function, it may instead perform no policing function or an alternative policing function in respect of the data in question.

According to preferred embodiments, the sender-side and in-network policing functions may correspond or be the same, but it will be appreciated that is some embodiments, they may not correspond.

According to preferred embodiments, the sender-side policing function and/or the in-network policing function may comprise determining if the data complies with predetermined criteria relating to one or more of:
network capacity requirements of the data;
network congestion caused or likely to be caused by the data;
sender and/or receiver identities indicated by the data;
a data item type or category of the data;
a measured property of the data such as a recent measurement of data rate, for example.

According to preferred embodiments, the sender-side policing function and/or the in-network policing function may comprise performing one or more of the following in respect of some or all of the data in dependence on a determination as to whether the data complies with predetermined criteria:
blocking or dropping some or all of the data;
reducing the rate at which some or all of the data is forwarded towards an intended receiving device for the data;
delaying onward transmission of some or all of the data;
forwarding some or all of the data towards a destination other than an intended receiving device for the data;
performing additional offline analysis in respect of some or all of the data;
imposing a charge in respect of some or all of the data;
assigning a sanction indication in respect of some or all of the data whereby to enable said data to be subjected to subsequent sanction;
associating a policing mark in respect of some or all of the data whereby to enable further policing action to be taken subsequently in respect thereof;
encrypting data;
sending on a different route or interface or slice or VPN;
re-coding the data to a different bit rate (compressing it, for example).

According to preferred embodiments, the method may comprise, in respect of data determined to have had a verification mark applied thereto verifying to the network device that a sender-side policing function has been performed in respect of the data, determining in dependence on the verification mark which of a plurality of different in-network policing functions are to be performed at the network device, and performing the in-network policing function determined in dependence on the verification mark.

According to preferred embodiments, the verification mark may be created using an encryption technique.

According to preferred embodiments, the verification mark may be dependent on content within one or more data items in respect of which it is applied (using an algorithm based on the content of one or more header fields and/or the payload in data packets, for example).

According to preferred embodiments, the verification mark may be a digital signature

The digital signature, cipher-mark or other such verification mark may be as short as a few bits, a pair of bits, or even a single bit per data item. While a longer mark with a large number of bits (i.e. allowing a large number of different codepoints) would make it less likely that a sender attempting to abuse the system by simply guessing the codepoint in question would guess correctly, a verification mark of only a small number of bits may be sufficient to dissuade such a sender. Even where just one bit is used (i.e. offering two possible codepoints), this may mean that a sender attempting to abuse the system by simply guessing the codepoint in question or using the same one for each packet they send may have approximately half of their packets policed, dropped or otherwise sanctioned as a result of in-network policing, which may be enough of a disincentive against abusing the system. Where more bits are used (i.e. offering more possible codepoints), a sender attempting to abuse the system in this way would have a smaller proportion of their data items trusted or accepted as having already been subjected to sender-side policing.

According to preferred embodiments, a verification mark in respect of an individual data item may be applied to that data item. Alternatively, a verification mark in respect of a plurality of data items may be applied to one or some of the plurality of data items, or a verification mark in respect of a plurality of data items may be applied across the plurality of data items.

Whatever form the verification mark takes, and however it is created, the verification mark is preferably not successfully or convincingly copy-able by a user attempting to abuse the system by copying the mark from correctly-marked data and applying it in respect of other data. This can be achieved by making it dependent on a hash-function of the content of the data item in question, for example.

According to preferred embodiments, one or more of the sending devices are end-user sending devices. Alternatively or additionally, one or more of the sending devices may be sender-side proxy devices outside a network-operator's communication network.

According to preferred embodiments, the method may further comprise forwarding at least some of the data from the network device towards an intended destination of the data, which may be outside the network-operator's communication network.

According to preferred embodiments, the method may further comprise forwarding at least some of the received data from the network device towards an intended destination of the data in a manner dependent on a result of the sender-side and/or in-network policing functions.

According to a second aspect of the invention, there is provided apparatus for policing data being sent across a communication network from a plurality of sending devices outside the communication network to one or more receiving devices, the apparatus comprising a network device in the communication network via which the data is sent, the network device being under a network operator's control, wherein the plurality of sending devices include:
one or more sending devices of a first type each having a secure computing environment under the network operator's control configured to perform a sender-side policing function in respect of data to be sent via the network and to apply a verification mark to said data verifying to the network device that the sender-side policing function has been performed; and
one or more sending devices of a second type not configured to perform the sender-side policing function in respect of data to be sent via the network nor to apply a verification mark to said data verifying to the network device that the sender-side policing function has been performed;

wherein the network device comprises:
a receiver configured to receive data from the sending devices; and
a processor configured to inspect received data in order to determine whether the data has had a verification mark applied thereto by a sending device having a secure computing environment under the network operator's control verifying to the network device that the sender-side policing function has been performed in respect of the data;
the network device having a policer configured to perform an in-network policing function in the event of a determination that the data has not had a verification mark applied thereto by a sending device having a secure computing environment under the network operator's control verifying to the network device that the sender-side policing function has been performed in respect of the data, and configured not to perform the in-network policing function at the network device otherwise.

According to a third aspect of the invention, there is provided a computer program element comprising computer program code to, when loaded into a computer system and executed thereon, cause the computer to perform the steps of a method according to the first aspect.

The various options and preferred embodiments referred to above in relation to the first aspect are also applicable in relation to the second and third aspects.

As indicated above, embodiments of the invention relate to the policing of data being sent across a network. Preferred embodiments are concerned with the challenge of making the policing of data (at a “network policer” device in a network operator's network) more efficient by arranging for some end-user or other “sending” (which includes “forwarding”) devices outside the network to perform at least some of the required/desired policing of at least some of the data they are sending (or forwarding).

A potential problem in this is that in general, a population of external “sending” end-hosts or other devices sending/forwarding data across a network may include some that can be trusted (by the network-operator) to perform (or assist in the performance of) operator-controlled policing, but others that cannot be similarly trusted. A network-operator's device (i.e. in the network-operator's network, somewhere between end-hosts sending data and end-hosts receiving data) can focus its policing more efficiently if it is able to determine, in respect of individual data items it receives (not just in dependence on which entities those data items have been received from) whether those data items have already been subjected to at least some level of sender-side policing by a trusted policer at or near the sending device outside the network (in which case the network-operator's policing device need not perform equivalent policing itself (or may perform a lower level of policing in respect of such traffic), or have been received from “ordinary” sending device without such trusted policing functionality (in which case the network device will generally perform full policing itself).

Preferred embodiments involve various mechanisms for assisting in this, and involve a policer module in a trusted sending device applying a verification mark to data it is going to send, the verification mark verifying to the network-operator's policing device within the network-operator's network that a policing function desired/required by the network-operator has been performed in respect of the data to which the verification mark has been applied before that data entered and was sent through the network-operator's network. Data from other sending devices (and possibly some data even from a trusted sending device) will not have such a verification mark. The network-operator's policing device in the network can distinguish in an efficient and reliable manner between already-policed (or already partially-policed) traffic from trusted sending devices and other traffic (i.e. generally that from ordinary or “untrusted” sending devices), and can therefore focus its policing accordingly.

The policer module may be a trusted computing module, a module in a Trusted Execution Environment (TEE), or a module in another such secure computing environment under the network operator's control. It may be implemented on a sending device or on an associated sender-side proxy device under the control of the network-operator, using an “enclave memory” (or “memory enclave”), for example.

Preferred embodiments make use of a verification mark (which may be a digital signature, a cipher-mark or another mark of a type that can't be convincingly copied or spoofed).

It will be appreciated that there might be more than one policing device in a particular network-operator's (or other such communication) network. If there is more than one, the policing devices may be co-located or be remote from each other, and may collaborate or act separately.

### BRIEF DESCRIPTION OF THE DRAWINGS

A preferred embodiment of the present invention will now be described with reference to the appended drawings, in which:

FIG. 1 shows the typical entities on an end-to-end path via a network operator's network;

FIG. 2 shows the primary entities which may be involved when data being sent on an end-to-end path via a network is policed using a method according to a preferred embodiment;

FIG. 3 illustrates possible details and functional modules of a sender-side trusted end-host and an ordinary end-host from which data may be sent for policing using a method according to a preferred embodiment;

FIG. 4 illustrates possible details and functional modules of network policer from may be used to implement a policing method according to a preferred embodiment;

FIGS. 5 and 6 show two possibilities for processes which may be performed by a network policer according to a preferred embodiment; and

FIG. 7 is a block diagram of a computer system suitable for use in performing methods according to preferred embodiments of the invention.

### DESCRIPTION OF PREFERRED EMBODIMENTS OF THE INVENTION

With reference to the accompanying figures, methods and apparatus according to preferred embodiments will be described.

Normally policing is performed (by or on behalf of a network operator) in the network operator's network in order to prevent “sending” end-hosts and other sending devices (such as routers forwarding data) from sending too much data, for instance. Policies might cover various factors, criteria and eventualities, such as sending at a particular time-of-day, or with a specific priority, or to specific end-points, or with a particular protocol. Policing may include security-related activities such as would usually be enforced by a firewall, and traffic-related items such as would be enforced by rate policers, and/or Deep Packet Inspection (DPI), etc.

Traditionally policing is performed in the network, for example at the point traffic leaves a customer's network and/or enters a network-operator's network (i.e. at a local area network (LAN) gateway device or the like) or at the first convenient point in the network-operator's network (for example the first router or other such IP device). Policing generally consists of some combination of security-related functions, such as “firewall” functionality, and traffic management related functions, such as bandwidth-shaping. However, it is attractive to police nearer the sending end of an end-to-end path because this can prevent unwelcome traffic from even entering the network, and also because it can allow the policing to be done before the traffic is encrypted, so the policing can potentially be tailored according to the traffic's content. A fuller list of potential benefits is as follows:
Policing as early as possible in the network can avoid carrying traffic through some of the network before it is dropped or managed (which wastes capacity)
Policing at an end-user's device reduces the complexity of devices that the network-operator has to deploy, since policing operations are instead performed by the end-user's device. Generally, there is spare computing-power available at the end-user device, but in any case, reducing the usage of computing-resources of a network-operator's devices is generally of benefit to the network-operator.
Policing at an end-user's device can allow more complex or accurate policing, as extra information about the traffic, session and/or user may be readily available at the end-host.
Policing at an end-user's device can allow for analysis of traffic prior to encryption of the data concerned. It is difficult for a device in the network to police encrypted traffic on anything other than bit-rate (while some information may be available in TCP headers, such as source and destination addresses and port numbers, this will diminish with the proposed “QUIC” protocol).
Since an end-user's device may be running virtualised functions, policing at an end-user's device may allow the policing to take account of other factors such as: whether virtualisation is used, the type of virtualisation (e.g. containers or Unikernel implementation), the process identity, etc.
Policing can be dependent on other activity on the end-user's device, for instance policy could be across a group of virtualised end-points or processes on a server.
If traffic needs to be buffered, this is generally cheaper and more scalable if done at or near end-hosts than in the network.
In some scenarios it may be beneficial to have a policing algorithm that is different for every end-host. This would generally be easier to implement via policers on the respective end-hosts than with a single policer in the network.

The above comments generally stem from on an assumption that a network-operator can trust policing done by a sender-side end-host or other sending-device. For example, the policer could be on a trusted computing module or in a Trusted Execution Environment (TEE) that is implemented on an end-host but which is under the control of the network-operator, or on an associated sender-side proxy device (similarly under the control of the network-operator), using an “enclave memory” (or “memory enclave”), for example.

However a network may be handling traffic from trusted-policing end-hosts (or other sending-devices) as well as ordinary (‘legacy’) end-hosts (or other sending-devices). It may therefore be necessary to police traffic from the latter but not police traffic from the former (or it may only be necessary or desired to perform a lighter-weight type of policing in respect of the former, for example). Thus a network operator's “in-network” policing device may need a way of easily distinguishing between the respective types of traffic.

Scenarios could include:
A broadband residential network, where the trusted policing is performed on end-user devices in the home.
A broadband residential network, where the trusted policing is performed on the home gateway device in the home.
A campus network, where the trusted policing is performed on end-user devices which are under the control of a campus network-operator.
A campus network, where the trusted policing is performed on end-user devices which are independent (i.e. not under the control of the campus network-operator).
A campus network, where the trusted policing is performed on a campus network gateway device.
A multi-site corporate network (with similar options to those listed above for broadband residential networks and campus networks, for example).
A specialist network, for example on a train where communications could be intermediated via an “app”.
A data-centre network, where functionality as a whole is under the control of a data-centre operator.

In some circumstances, for example in a data-centre, it may be possible to assume that all traffic comes from an end-host with a trusted policer, in which case there may be no need for a policer in the network, but in other scenarios which at first sight might seem similar, for example a campus network where only approved devices are allowed to attach, the difference may be that it takes a considerable period of time to roll out to all end-hosts an upgrade to a trusted policer. Thus the operator may want to perform policing in the network on traffic from end-hosts that are yet to be upgraded.

In other scenarios, for example a broadband residential network, some end-user devices may have a trusted policer and some may not. Thus a network operator may need or wish to perform policing which is focussed on the latter. It could for example perform this policing at a Broadband Network Gateway (BNG), which is typically the bottleneck link in a network.

The scenarios above also show that a trusted policer, rather than having to be at a sending end-host, could be at a gateway between a local network and the network-operator's network (for example at the “home router” of a local network). Another possibility is that there is a single physical machine that hosts multiple virtual machines (only some of which perform trusted policing).

Typically the “in-network” policer is in the network close to the sending end-user devices, as that is where a normal policer is best placed (for reasons discussed above). It may also be placed deeper in the network, nearer to the receiving end-host, or a receiving network.

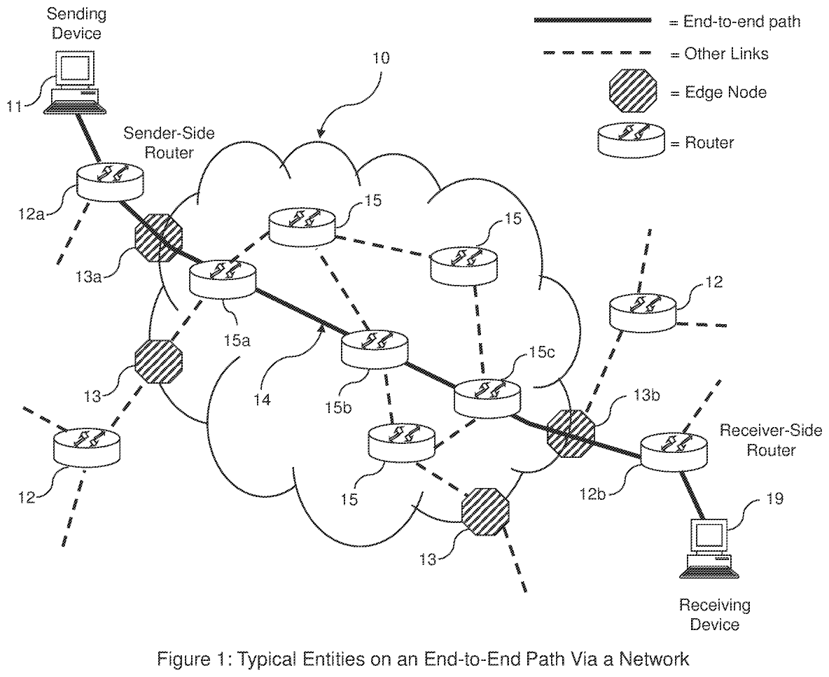

With reference to the figures, preferred embodiments will now be described in the context of an exemplary scenario in which the sending and receiving devices are the original “sending” and eventual “receiving” end-hosts, and in which there is just one “routing-and-policing” device in the network operator's network (to avoid the need to complicate the example with intermediate routers inside or outside the network operator's network). It will be appreciated that in general, there would also be other (generally a large number) of routing devices inside and outside the network operator's network, as indicated in FIG. 1, and that the “sending device” performing a specific policing function as part of such an embodiment may be a sender-side router or other such device between the original “sending” end-host and the boundary of the network operator's network.

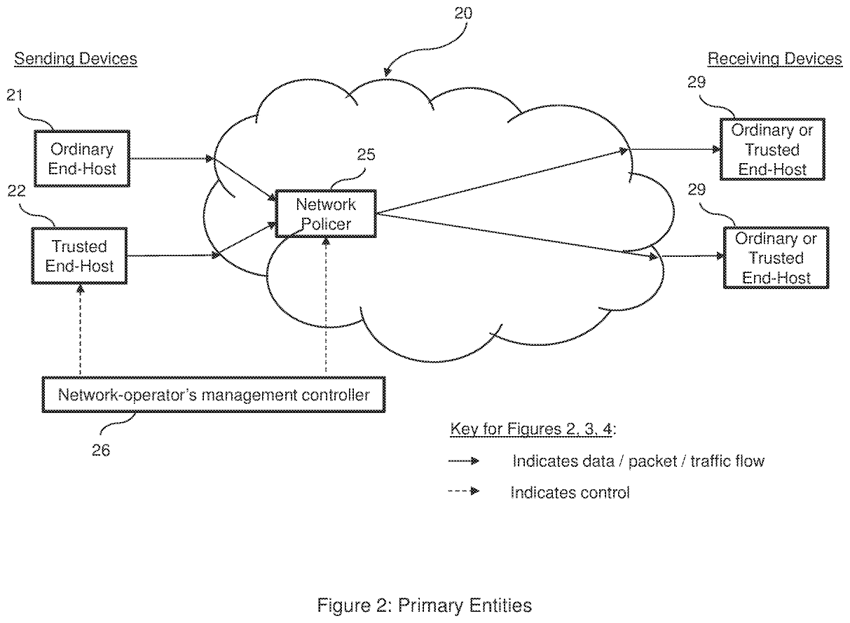

FIG. 2 shows in simplified form the primary entities which may be involved when data being sent on an end-to-end path via a network operator's network 20 is policed using a method according to a preferred embodiment. Two sending devices 21, 22 are shown, which in this simple example are original sending end-hosts. The first of these is an “ordinary” end-host 21, but the second is a “trusted” end-host 22 with a trusted-policing function. Both types may be sending data to receiving devices 29 (which for the purposes of this explanation may be “ordinary” or “trusted” end-hosts—whether they are “ordinary” or “trusted” is not of particular importance in relation to this example, in which data is only being sent in the direction indicated by the unbroken arrows). In the network 20 is a network policer 25. Also shown is a network-operator's management controller 26. The location of the management controller 26 may be inside or outside the network 20. In this example, the management controller 26 is able to communicate with or have some control over the functionality of the trusted end-host 22 and the network policer 25 (as indicated by the dotted arrows), possibly on an ongoing basis (e.g. in order to provide instructions, software updates, etc.), but possibly only in relation to their initial configuration—it is not necessary for any such control, however. As will become apparent, the configuration of the trusted end-host 22 and the network policer 25, or the communication between them and the management controller 26 may relate to details of a cipher-marking or other such “verification marking” algorithm (e.g. a secret key, input fields of packets, how/where to write a verification mark, etc.).

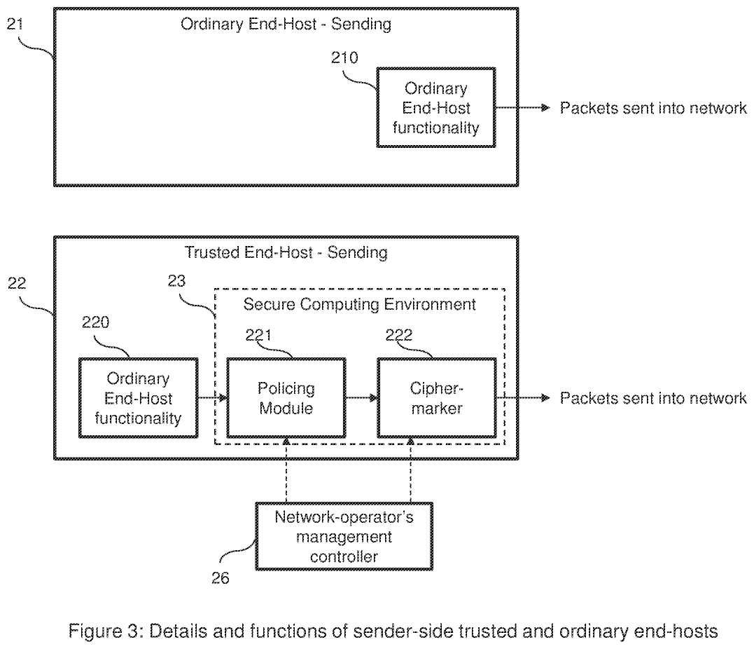

FIG. 3 illustrates details of an ordinary (i.e. untrusted) end-host 21 and a trusted end-host 22 such as those shown in FIG. 2, each acting in the role of a sending device (noting, as before, that this may be an originating sender such as sending device 11, or a forwarding device such as sender-side router 12a, both shown in FIG. 1). The ordinary (i.e. untrusted) end-host 21 may simply have ordinary end-host functionality, denoted by box 210. The trusted end-host 22, as well as having corresponding ordinary end-host functionality 220, has a secure computing environment 23 comprising a policing module 221 and, in the preferred implementation, a cipher-marker function 222 (or other such verification-marking function). As in FIG. 2, the dotted lines indicate that the network-operator in this example has some control over the latter two functions via a controller 26 (although the relationship between the two may just involve communication to exchange a secret, or establish collaboration, for example). With reference to the order of the three functional modules connected with solid arrows, the order shown is typical but is not mandatory, and in general, some ordinary end-host functionality would be likely to occur after the cipher-marker 222 has performed its function, in order to actually transmit the traffic. The order of the policing module 221 and cipher-marker module 222 may be reversed in some embodiments, for example. This may be the case if end-to-end encryption is being used, as the marking algorithm may need to be run on encrypted data.

The secure computing environment 23 may comprise just the policer module 221, which may be a trusted computing module, a module in a Trusted Execution Environment (TEE), or a module in another such secure computing environment under the network operator's control. It may be implemented on the trusted end-host 22 itself or on an associated proxy device thereof under the control of the network-operator, using an “enclave memory” (or “memory enclave”), for example.

It will be understood that in addition to cipher-marks, alternative types of verification mark may be used, including one-time (i.e. single-use) or time-limited passwords, digital signatures or other such marks which may be created using any of a variety of encryption or encoding techniques. Preferably such techniques involve use of a cipher or other such secret such that the verification mark cannot be convincingly copied and used (fraudulently) in other data by other parties, or spoofed. It may be dependent on the content of the data being sent, meaning that a mark found in and copied from one data item then used (fraudulently) in another data item will be immediately recognisable on inspection (discussed later) by a network operator's policing device as invalid, so will not succeed in verifying to the network operator's device that the data item has been received from a trusted end-host 22 (so cannot be assumed to have been subjected to the sender-side policing desired/required).

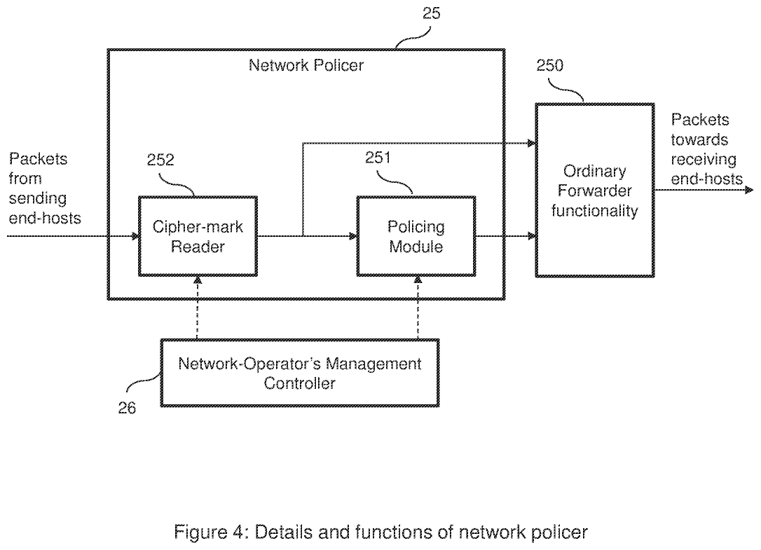

FIG. 4 shows the corresponding details for the network policer 25. This has a cipher-mark reader 252 which inspects the data received from the sending end-hosts and checks the cipher-mark (or other such verification mark) of the data items. Based on the results of this check, data items of the traffic are directed (possibly data-item-by-data-item) for policing at a policing module 251 if necessary (i.e. if there is no applicable verification mark, or an invalid verification mark, or a verification mark indicating that reduced policing is applicable in respect of the data item in question), or by-pass the policing module 251 if they have a verification mark verifying to the cipher-mark reader 252 that sender-side policing has already been performed in respect of the data. As in FIG. 2, the dotted lines indicate that the network-operator controls the functionality of the cipher-mark reader 252 and the policing module 251 via the control function 26, which can provide instructions, software updates, ciphers, decryption codes, etc. as applicable. Also shown is an ordinary forwarder functionality module 250 which is configured to forward data items (whether policed by the policing module 251 or not) on towards their respective receiving end-hosts. This may be a part of the network policer 25 with or without routing functionality, or may be a separate routing entity such as a network router.

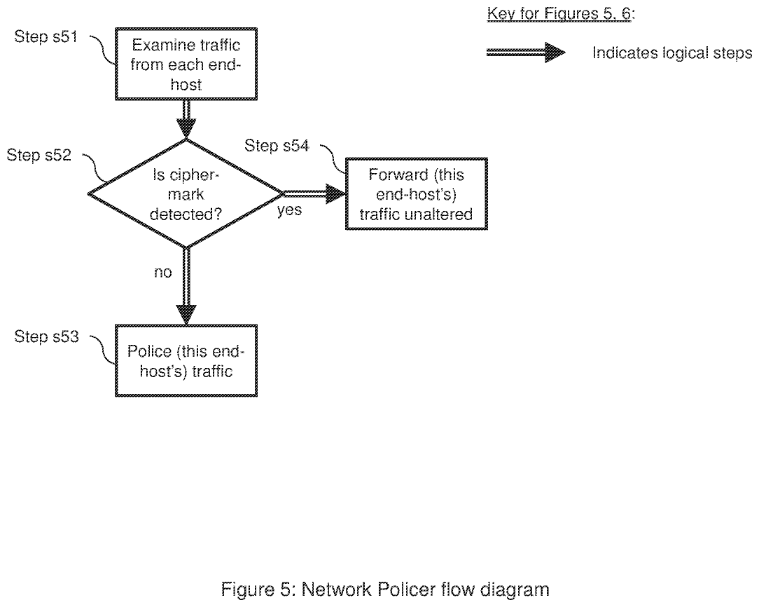

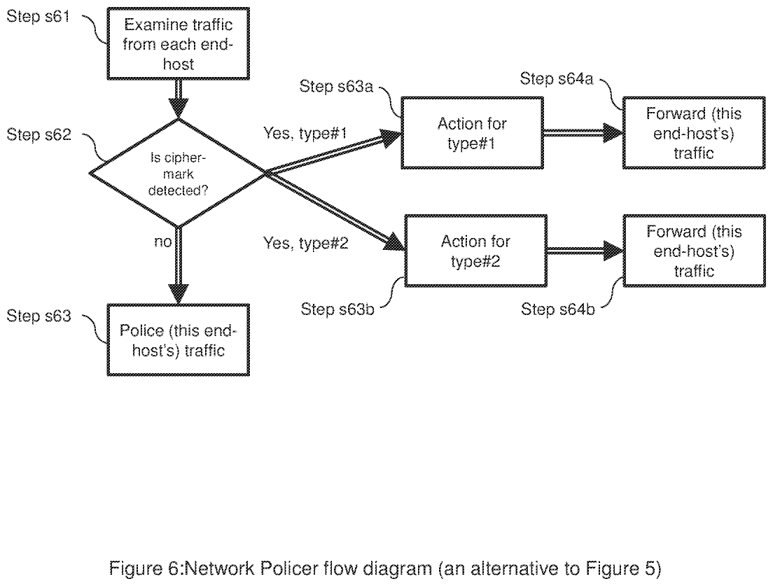

FIGS. 5 and 6 show two possibilities for the process carried out by a network policer 25 such as that shown in FIGS. 2 and 4. Briefly, in FIG. 5, based on whether or not a cipher-mark (or other such verification mark) is detected in traffic received by the network policer 25, the traffic is either forwarded directly (i.e. without any “in-network” policing) towards its intended destination (i.e. if it has a valid verification mark) or it is directed to the policing module 251 in the network policer (as shown in FIG. 4) for in-network policing (i.e. if it doesn't have a valid verification mark), whilst in FIG. 6, more than two options are possible based on the determination at the network policer 25.

Looking in more detail at FIG. 5, in this example (in which the process is performed by a network policer 25 such as that shown in FIG. 4, and a cipher-mark is used as the verification mark), the network policer 25 performs the following functions:

In Step s51, the cipher-mark reader 252 inspects data items received from the sending end-hosts and checks for cipher-marks.

If a data item is found at Step s52 not to have a valid cipher-mark (i.e. so does not have a mark verifying that it, or the flow, or the traffic of which it forms a part has come from or via a trusted sender-side policer 22 and/or that it has been subjected to sender-side policing there), the traffic is passed to the policing module 251, at which the data item, flow or traffic in question is subjected to in-network policing (Step s53). The in-network policing might involve one or more of policing options such as blocking or dropping traffic completely, or forwarding (or allowing traffic to be forwarded) but only at a slow rate, or forwarding traffic unaltered but performing more intensive offline analysis, or imposing a charge, etc., or a combination of approaches.

If it is found at Step s52 that the data item does have a valid cipher-mark (i.e. a mark verifying that it, or the flow, or the traffic of which it forms a part has come from or via a trusted sender-side policer 22 and has been subjected to sender-side policing there), the traffic is passed to the forwarding module 250 (or alternatively may be policed using lighter-weight policing before being passed to the forwarding module 250, for example), and is then forwarded (generally unaltered) on towards its intended receiving end-host (Step s54).

As discussed above, some or all of the functional modules performing the above steps may be connected to a management control function, which can update the other functions (for example, with an updated “distinguishing” function in Step s51 (for instance an update of the private key used by the cipher-marking algorithm, as discussed below). In this way the network operator can reconfigure or manage the functions if/when applicable.

Referring next to FIG. 6, this is similar in some ways to FIG. 5, but indicates how more than two options may be possible based on the cipher-mark (or other such verification mark) determination made at the network policer 25. Steps s61, s62 and s63 in FIG. 6 correspond essentially to steps s51, s52 and s53 in FIG. 5, but three (rather than two) options are shown resulting from the determination at Step s62, as follows.

The cipher-mark reader 252 inspects received data items in Step s61. If no cipher-mark is found at Step s62, the traffic is passed to the policing module 251 as before, and the data item, flow or traffic in question is subjected to in-network policing of one type or level (e.g. “full policing”) at Step s63, on the basis that no sender-side policing has been performed in respect thereof. If a cipher-mark is found at Step s62, it may (in this example) be of two different types (potentially more than two). If the cipher mark is of a first type (“type#1”), the data item, flow or traffic in question may be subjected to a first type of action at Step s63a, which may for example involve simply being passed unaltered for forwarding (Step s64a) without any in-network policing. If the cipher mark is of a second type (“type#2”), the data item, flow or traffic in question may be subjected to a second type of action at Step s63b, which may for example involve being subjected to “light” or “partial” in-network policing, on the basis that some sender-side policing has already been performed in respect thereof by a trusted policing module at a trusted sending-device. Subject to this “light” or “partial” in-network policing, the data item, flow or traffic in question may then be passed (perhaps altered, delayed or subject to a charge) for forwarding (Step s64a).

Other options and numbers of options are possible.

As discussed above, a variety of different types of verification mark may be used, an example of which is a “cipher-mark”. This may be an electronically-encoded or encrypted watermark created by a trusted sending-device using a cipher, generally together with at least a portion of the data to be sent, such as to be dependent on the data to which it is applied, making it virtually impossible for an untrusted sending-device to create or re-create it. As set out in the “Introduction” section of the “Survey” paper by lacovazzi and Elovici discussed in the “Background” section of the present description, a watermark itself may be regarded as “a small piece of information that can be used to uniquely identify a connection”. A cipher-mark may be regarded as a small piece of information that is added by a module such as the cipher-marker 222 in the Trusted End-Host 22 of FIG. 3 in order that the network policer 25 can distinguish (in Step s52 of FIG. 5 or Step s62 of FIG. 6) whether or not the traffic comes from a trusted sending-device and has been (at least partially) policed. The cipher-mark may be in every data item (e.g. packet), in an occasional data item, or spread across multiple data items. Note that the cipher-mark or verification mark may not uniquely identify a connection (whereas the “Survey” paper discussed above defines a watermark as uniquely identifying a connection).

Advantageous properties of a cipher-mark may include one or more of the following:

(i) it is relatively low ‘cost’ (in terms of processing, at least) for the sender-side trusted sending-device to add it;

(ii) it is relatively low ‘cost’ for a network policer 25 to detect whether it is present or not;

(iii) it is relatively hard for a non-compliant sending-device to spoof or fake it;

(iv) it is relatively robust to loss of some data items.

Advantageously, a cipher-marking algorithm's variables may include one or more of the following:

(i) the input data to the algorithm (e.g. the first data byte, plus a secret key, for example);

(ii) the calculation made (e.g. a secret algorithm, resulting in either a ‘1’ or ‘0’, for example);

(iii) the output's encoding (e.g. in the ECN field).

Some examples of how the output may be encoded could include:

(i) the output being encoded in the ECN field across one packet or multiple packets;

(ii) the output being encoded in the Identifier field of IPv4 packets, either in one packet or across multiple packets;

(iii) the output being encoded in part of the data (for instance in the first byte), either in one packet or across multiple packets;

(iv) the output being encoded in the Traffic Class field of IPv6 packets, either in one packet or across multiple packets;

(v) the output being encoded in an IPv6 extension header, either in one packet or across multiple packets.

The cipher-mark algorithm could be a form of digital signature (a digital signature being a scheme that gives the receiver justification for believing that the message was sent by the claimed sender). Most commonly digital signature schemes employ asymmetric cryptography; a message is signed by Alice by using her private key to calculate the message's signature; Bob receives the message and checks, using Alice's public key, that the signature is valid for the received message. One method is to use a cipher-mark generated in this fashion, or any of the other known methods for digital signatures.

Another method is to use symmetric keys, since the processing power required to verify the signature is generally less than with asymmetric cryptography and the operator may want to restrict the processing power required by its network policer 25. Another advantage, specific to this patent application, is discussed below.

Another alternative is that the digital signature produced is just 1-bit (or a small number). (The benefit, in the context of this patent application, is that it can then easily fit in a packet header). If the network policer calculates a different value (a ‘1’ instead of a ‘0’ for instance) then the packet is dropped. An attacker that guesses the signature bit would therefore have half its packets dropped, which could be a sufficient deterrent to most attackers. (An attacker here means a sender who is not trusted but seeks to fool the network policer into treating it as though it is a trusted sender.) One approach an attacker could take is to send every packet twice, once with the signature bit set as ‘1’ and once with it set as ‘0’. The network policer may need to protect itself through further measures (such as occasional offline analysis to spot senders of multiple duplicate packets, and then block all traffic from the sender, for instance). Alternatively, or in addition, it could make the digital signature longer (for instance 4-bits would require each bit to be sent 16 times). With some digital signature schemes it would also be possible for an attacker to perform the same calculation as the network policer. For example, a digital signature using asymmetric keys and a 1-bit signature. The sender can perform the same calculation as the network policer (since it knows the data and the public key) and then set the signature bit to the correct value. One alternative approach is to use asymmetric keys, but ensure both are private, in particular so that the sender does not know the key used by the policer nor the keys used by other senders. Another approach is to use symmetric private keys (since an untrusted sender doesn't know a true private key).

Referring again to the steps of the process illustrated in FIG. 5, the mechanism in Step s51 may involve checking the relevant field in one packet or across multiple packets to see if the information matches what is expected (and therefore verify that the packet(s) or traffic flow has come from a trusted sending-device which has performed the required/desired policing in respect of the data). The details depend on the cipher-mark algorithm being used.

In the more specific example with a single bit verification mark, Step s51 may use the same secret key and hash against the same bytes in the payload when it receives the packet. If it doesn't match the single-bit hash value the packet may be dropped. This means that a sending-device abusing the system will get approximately a 50% packet loss (since it is trying to “guess” a single-bit hash-value and will get it wrong approximately half of the time). As an additional technique, the network policer 25 could identify flows from which it drops (on average) approximately 50% of the packets and could perform further action in respect thereof (for instance if a sending-device was cheating by sending every packet twice, duplicated except for inverting the single bit, then 50% of packets would be dropped). Alternatively, rather than directly dropping packets, the flow could be put into a “treat with caution” category, perhaps for further investigation.

If using “rolling” private keys or different private keys for each IP address/subnet, a possible complication may involve syncing the private key. In other words, if the private key is changed, it may then be necessary (at least temporarily) to check against both the current key and the historic key. Consider for example a scenario where there are a large number of end hosts and the network operator decides to change the key on all the hosts, then, for a period of time, the network policer may not know which are using their old key and which are using their new key, so it may be easiest for the network policer to treat both as valid. Depending on how often the key is changed and the speed of the key update procedure, it may even be necessary to check against further historic keys. The packet-loss-penalty suffered by a cheating end-host will be approximately 50% if the policer checks against one key, 25% against two keys and 12.5% against three keys, and so on.

It will be noted that the algorithm may be based only on data (i.e. without using a secret key). This is less preferred as its security may then rely on the secrecy of the algorithm itself.

Another possibility will be briefly described with reference to FIG. 6. For different classes of sending-devices, their associated trusted policers run a different cipher-marking algorithm (or use a different key, or apply a different type of verification mark, for example). This would enable the network-policer to differentiate whether the sender is “type#1” or “type#2” (as indicated in FIG. 6). The action it takes in respect of data from them could be different for these different types. For example, the types could enable different action for:
Those who are a mobile operator's customers vs those of a virtual mobile operator;
Those who are a mobile device vs residential gateways that are using the mobile network for access (either instead of fixed broadband, or as a boost or back-up in conjunction with fixed broadband);
Those on residential contracts vs those on enterprise contracts;
Those who are running the Congestion Exposure (ConEx) algorithm vs those who are not;
Those who are guaranteed to be obeying the TCP algorithm (in the trusted sender) vs those who are not so guaranteed.

In general this mechanism allows there to be different types of trusted sending device (not limited to just the two types in FIG. 6), where the network policer needs to take different action. For instance, in the first example of the bullet list, the network policer may take no action for its own customers, whereas it may normally take no action for the virtual mobile operator's customers but may police them if its network is congested.

Variants could include where the types distinguish between different applications on the same sender; and where the same cipher-mark algorithm is used but with a different key.

A further possibility is where the (end-user) sending devices are simple, for example “Internet of Things” (IoT) devices for which the 3GPP AAA mechanisms may be too complex or have too high a processing or networking overhead, or require too many signalling round trips. In this case the cipher-mark may be used to indicate, in a trusted yet simple fashion, what ‘class’ the end-user device is and thus for instance what parts of the AAA mechanism the sending device has performed and what parts the network needs to do on its behalf.

Whilst Step s51 may seem more complex than the measurement part of some policing algorithms (for instance, those which just measure rate from an end-host) (which would reduce or eliminate the purpose of the cipher-marking), the following will be noted:
For each end-host (source of traffic), Step s51 may be run initially. For data from sources whose previous (or at least recent) data has been found to have a valid cipher-mark (or other such verification mark) (i.e. indicating that it has been received from a trusted sending end-host), Step s51 may subsequently be replaced by a much simpler algorithm (for example just checking the source address) and then occasionally re-checking the cipher-mark (and/or the traffic) to make sure that the end-host in question can still be trusted to be running a policer.
The security functionality parts of a policer are typically complex and harder to implement than the traffic management part. This is especially true where the traffic is encrypted and therefore complex heuristics are needed to decide if the traffic is permitted. It is therefore advantageous if the cipher-mark enables the network policer to know that the necessary security steps have been done on the sending device.

This approach could be applicable where there is a VPN or network slice. It may then be considered likely that sending end-hosts are trusted (for example, corporate computers using a VPN). The purpose of checking the verification mark may therefore be to make sure this is true initially, and subsequently on an occasional basis.

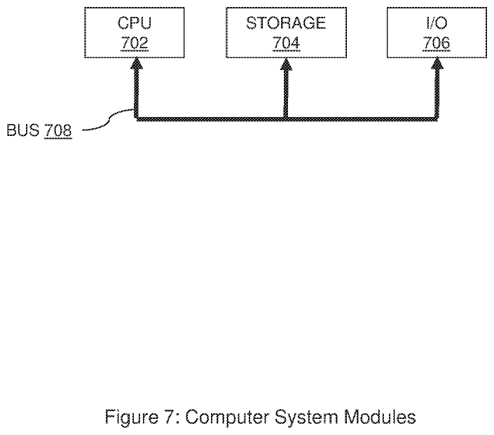

FIG. 7 is a block diagram of a computer system suitable for the operation of embodiments of the present invention. A central processor unit (CPU) 702 is communicatively connected to a data store 704 and an input/output (I/O) interface 706 via a data bus 708. The data store 704 can be any read/write storage device or combination of devices such as a random access memory (RAM) or a non-volatile storage device, and can be used for storing executable and/or non-executable data. Examples of non-volatile storage devices include disk or tape storage devices. The I/O interface 706 is an interface to devices for the input or output of data, or for both input and output of data. Examples of I/O devices connectable to I/O interface 706 include a keyboard, a mouse, a display (such as a monitor) and a network connection.

Insofar as embodiments of the invention described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present invention. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disk or tape, optically or magneto-optically readable memory such as compact disk or digital versatile disk etc., and the processing device utilises the program or a part thereof to configure it for operation. The computer program may be supplied from a remote source embodied in a communications medium such as an electronic signal, radio frequency carrier wave or optical carrier wave. Such carrier media are also envisaged as aspects of the present invention.

It will be understood by those skilled in the art that, although the present invention has been described in relation to the above described example embodiments, the invention is not limited thereto and that there are many possible variations and modifications which fall within the scope of the invention.

The scope of the invention may include other novel features or combinations of features disclosed herein. The applicant hereby gives notice that new claims may be formulated to such features or combinations of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A method of policing data being sent from a plurality of sending devices to one or more receiving devices via a network device in a communication network, the network device being under a network operator's control, the plurality of sending devices including:
one or more sending devices of a first type each having a secure computing environment under the network operator's control configured to perform a sender-side policing function in respect of data to be sent via the network and to apply a verification mark to said data verifying to the network device that the sender-side policing function has been performed; and
one or more sending devices of a second type not configured to perform the sender-side policing function in respect of data to be sent via the network nor to apply a verification mark to said data verifying to the network device that the sender-side policing function has been performed;
the method comprising, at the network device:
receiving data from one of the plurality of sending devices;
inspecting the data in order to determine whether the data has had a verification mark applied thereto by a sending device having a secure computing environment under the network operator's control verifying to the network device that the sender-side policing function has been performed in respect of the data;
in the event of a determination that the data has not had a verification mark applied thereto by a sending device having a secure computing environment under the network operator's control verifying to the network device that the sender-side policing function has been performed in respect of the data, performing an in-network policing function at the network device;
and otherwise not performing the in-network policing function at the network device.

2. A method according to claim 1 wherein the sender-side and in-network policing functions correspond or are the same.

3. A method according to claim 1 wherein the sender-side policing function and/or the in-network policing function comprise determining if the data complies with predetermined criteria relating to one or more of:
network capacity requirements of the data;
network congestion caused or likely to be caused by the data;
sender and/or receiver identities indicated by the data;
a data item type or category of the data;
a measured property of the data.

4) A method according to claim 1 wherein the sender-side policing function and/or the in-network policing function comprises performing one or more of the following in respect of some or all of the data in dependence on a determination as to whether the data complies with predetermined criteria:
blocking or dropping some or all of the data;
reducing the rate at which some or all of the data is forwarded towards an intended receiving device for the data;
delaying onward transmission of some or all of the data;
forwarding some or all of the data towards a destination other than an intended receiving device for the data;
performing additional offline analysis in respect of some or all of the data;
imposing a charge in respect of some or all of the data;
assigning a sanction indication in respect of some or all of the data whereby to enable said data to be subjected to subsequent sanction;
associating a policing mark in respect of some or all of the data whereby to enable further policing action to be taken subsequently in respect thereof;
encrypting data;
sending on a different route or interface or slice or VPN;
re-coding the data to a different bit rate.

5) A method according to claim 1 wherein the method comprises, in respect of data determined to have had a verification mark applied thereto verifying to the network device that a sender-side policing function has been performed in respect of the data, determining in dependence on the verification mark which of a plurality of different in-network policing functions are to be performed at the network device, and performing the in-network policing function determined in dependence on the verification mark.

6) A method according to claim 1 wherein the verification mark is created using an encryption technique.

7) A method according to claim 1 wherein the verification mark is dependent on content within one or more data items in respect of which it is applied.

8) A method according to claim 1 wherein the verification mark is a digital signature.

9) A method according to claim 1 wherein a verification mark in respect of an individual data item is applied to that data item.

10) A method according to claim 1 wherein one or more of the sending devices are end-user sending devices.

11) A method according to claim 1 wherein one or more of the sending devices are sender-side proxy devices outside a network-operator's communication network.

12) A method according to claim 1 wherein the method further comprises forwarding at least some of the data from the network device towards an intended destination of the data.

13) A method according to claim 1 wherein the method further comprises forwarding at least some of the received data from the network device towards an intended destination of the data in a manner dependent on a result of the sender-side and/or in-network policing functions.

14. Apparatus for policing data being sent across a communication network from a plurality of sending devices outside the communication network to one or more receiving devices, the apparatus comprising a network device in the communication network via which the data is sent, the network device being under a network operator's control, wherein the plurality of sending devices include:
one or more sending devices of a first type each having a secure computing environment under the network operator's control configured to perform a sender-side policing function in respect of data to be sent via the network and to apply a verification mark to said data verifying to the network device that the sender-side policing function has been performed; and
one or more sending devices of a second type not configured to perform the sender-side policing function in respect of data to be sent via the network nor to apply a verification mark to said data verifying to the network device that the sender-side policing function has been performed;
wherein the network device comprises:
a receiver configured to receive data from the sending devices; and
a processor configured to inspect received data in order to determine whether the data has had a verification mark applied thereto by a sending device having a secure computing environment under the network operator's control verifying to the network device that the sender-side policing function has been performed in respect of the data;
the network device having a policer configured to perform an in-network policing function in the event of a determination that the data has not had a verification mark applied thereto by a sending device having a secure computing environment under the network operator's control verifying to the network device that the sender-side policing function has been performed in respect of the data, and configured not to perform the in-network policing function at the network device otherwise.

15) A computer program element comprising computer program code to, when loaded into a computer system and executed thereon, cause the computer to perform the steps of a method as claimed in any of claim 1.
